(19) United States
(12) Patent Application Publication
(10) Pub. No.: US 2005/0179588 A1
(43) Pub. Date: Aug. 18, 2005

(54) User password apparatus and method using car-call

(76) Inventor: Nam-Woo Kim, Siheung-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/070,046

(22) Filed: Mar. 1, 2005

Related U.S. Application Data
(63) Continuation of application No. PCT/KR03/01789, filed on Sep. 2, 2003.

(30) Foreign Application Priority Data
Sep. 2, 2002 (KR) 10-2002-0052420

(51) Int. Cl. G01S 1/00

(52) U.S. Cl. 342/357.07; 340/463

(57) ABSTRACT

The present invention relates to a user password apparatus and method using car-call. An apparatus for setting and releasing a user password to control the automotive component comprises a signal detector for detecting a physical signal that is applied to a car and converting the physical signal into an electrical signal, a controller for storing the entered password if the electrical signal is a password setup/change signal, controlling an operation of the corresponding automotive component if the electrical signal is a password release signal and the entered password coincides with the stored password, and generating an user call signal if it is needed to call the user according to the analysis, a wireless transmitter for wirelessly transmitting the user call signal to a remote controller, and a wireless receiver for wirelessly receiving a vehicle control signal from the remote controller.

### RELATED APPLICATIONS

This application is a continuation application, and claims the benefit under 35 U.S.C. §§ 120 and 365 of PCT Application No. PCT/KR2003/001789, filed on Sep. 2, 2003 and published Mar. 11, 2004, in English, which is hereby incorporated by reference.

### BACKGROUND OF INVENTION

1. Filed of the Invention

The present invention relates to a user password apparatus and method using a car-call, more particularly, with which a user can control automotive electrical components/equipments by applying signals in the specific form on the vehicle's body.

2. Description of the Related Technology

Conventionally, an alarming device or a remote controlling device for starting engine on the vehicle must be installed in order to check the state of vehicle and controlling vehicle. Thus, the conventional vehicle control device and remote controller have functions of engine control and car-call.

FIG. 1 is a block diagram of a conventional car-call system. Referring to FIG. 1, the conventional car-call system includes a vehicle alarm device 100 and remote controller 110. The vehicle alarm device 100 as a main unit being installed on the vehicle includes an impact detecting part 101, the first controller 102, an alarm sound generator 103, a wireless transmitter 104 and the first antenna 105. The remote controller 110 includes the second antenna 111, a wireless receiver 112, the second controller 113 and a display 114. Hereinafter, the operation of the conventional car-call system will be described.

The impact detecting part 101 detects a physical signal, that is, impact due to theft or user call, generates an impact signal, that is, an electrical signal corresponding to the impact, and outputs the impact signal to the first controller 102. On receiving the impact signal, the first controller 102 outputs an user calling signal indicating there is the impact or user call to the wireless transmitter 103 and outputs a control signal for generating an alarm sound to the alarm sound generator 103. The wireless transmitter 104 transmits the user calling signal to the second antenna of the remote controller 110 through the first antenna 105. The alarm sound generator 103 generates the predetermined alarm sound according to the control signal from the first controller.

The wireless receiver 112 of the remote controller 110 receives the user calling signal from the vehicle alarm device 100 through the second antenna 111 and outputs the received signal to the second controller 113. The second controller 113 outputs a control signal corresponding to the user calling signal to the display 114, and according to the control signal, the display 114 turns on lamp to let the use be aware of user call.

As described above, the conventional technology has some weak points that the user can control the vehicle only in some restricted situations.

Also, since the conventional technology depends solely on the remote controller, in the case of locking the door with leaving remote controller in the inside of car, there is no way to control the car without breaking windows or opening doors by force.

### SUMMARY OF CERTAIN INVENTIVE ASPECTS OF THE INVENTION

One aspect of the present invention provides a function of setting and certifying password in a car-call system in order to unlock doors or control automotive electrical components/equipments without a key or remote controller even if the user unlocks the door with leaving key or remote controller in the inside of car.

Another aspect of the present invention provides an apparatus and method with which anyone can call the user directly from the car in the case of need.

Another aspect of the present invention controls the main functions of car without a key or remote controller.

Another aspect of the present invention provides an apparatus for setting and releasing a user password to control the automotive component in a car-call system comprises a signal detector for detecting a physical signal that is applied to a car and converting the physical signal into an electrical signal, a controller for analyzing the electrical signal, storing the entered password if the electrical signal is a password setup/change signal according to the analysis, controlling an operation of the corresponding automotive component if the electrical signal is a password release signal and the entered password coincides with the stored password according to the analysis, and generating an user call signal if it is needed to call the user according to the analysis, a wireless transmitter for transmitting the user call signal to a remote controller by wireless, and a wireless receiver for receiving a vehicle control signal from the remote controller by wireless, wherein said controller controls the operation of automotive component according to the vehicle control signal.

Still another aspect of the present invention provides a method for setting a user password to control automotive components in a car-call system, the method comprises the steps of: detecting a password setup signal that is applied to a car in the form of a physical signal having the predetermined format in a ready state for setting password, generating a confirmed signal indicative of a normal password setup state, if the applied password setup signal corresponds to the stored password setup signal, detecting the password that is applied to the car in the form of a physical signal having the predetermined format in the password setup state, and storing the password after generating a confirmed signal indicative of an end of password input if the password is inputted normally.

Yet another aspect of the present invention provides a method for releasing a user password to control automotive components in a car-call system, said method comprises: detecting a password release signal that is applied to a car in the form of a physical signal having the predetermined format, generating a confirmed signal indicative of a normal password input state if the applied password release signal corresponds to the stored password release signal, detecting a password that is applied to the car in the form of a physical signal having the predetermined format in the password input state, and generating a confirmed signal indicative of valid password and controlling the automotive component if the applied password corresponds to the stored password.

### BRIEF DESCRIPTION OF THE DRAWINGS

FIG. 1 is a block diagram of a conventional car-call system.

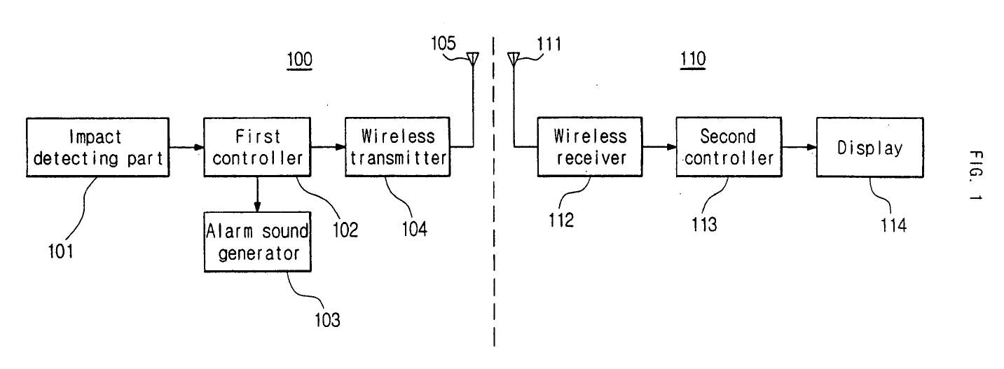

FIG. 2 is a block diagram of the car-call system using Piezzo buzzer according to one embodiment of the present invention.

FIG. 3 is a block diagram of the car-call system using light sensor according to one embodiment of the present invention.

FIG. 4 is a block diagram showing the control function of the car-call system according to one embodiment of the present invention.

FIG. 5 is a block diagram of the remote controller according to one embodiment of the present invention.

FIG. 6 is a flowchart of method for setting user password in the a car-call system according to one embodiment of the present invention.

FIG. 7 is a flowchart of method for releasing user password in the car-call system according to one embodiment of the present invention.

### DETAILED DESCRIPTION OF CERTAIN EMBODIMENTS OF THE INVENTION

Hereinafter, embodiments of the present invention will be described in further detail with accompanying drawings.

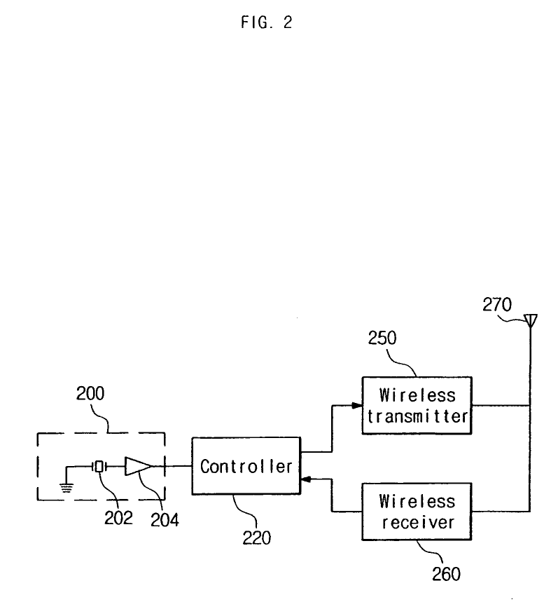

FIG. 2 is a block diagram of the car-call system using Piezzo buzzer according to one embodiment of the present invention.

Referring to FIG. 2, the car-call system includes a signal detector 200, a controller 220, a wireless transmitter 250, a wireless receiver 260 and an antenna 270.

The signal detector 200 includes a Piezzo buzzer 202 and signal amplifier 204. When a regular or irregular signal is applied, a diaphragm the Piezzo buzzer moves up and down to generate sound of from 1000 to 2500 KHz. Using this operation, the Piezzo buzzer 202 as a piezoelectric element performs a function of one embodiment of the present invention.

Thus, when a pressure caused by sound is applied, the Piezzo buzzer 202 converts the pressure into an electrical signal. And, the amplifier 204 amplifies the converted electrical signal. The controller 220 uses the amplified signal to control the automotive electrical components/equipments. If the signal detector 200 includes the Piezzo buzzer 202, the user can unlock the doors by knocking the body of the car by predetermined number of times or at predetermined interval.

Among plural functions of the controller 220, if communication with the remote controller is needed, the electrical signal outputted from the controller 220 is converted into a wireless signal at the wireless transmitter 250. The wireless signal is transmitted to the remote controller through the antenna 270. Further, the wireless signal received at the antenna 270 is converted into an electrical signal at the wireless receiver 260 and is outputted to the controller 220 for controlling the automotive electrical components/equipments.

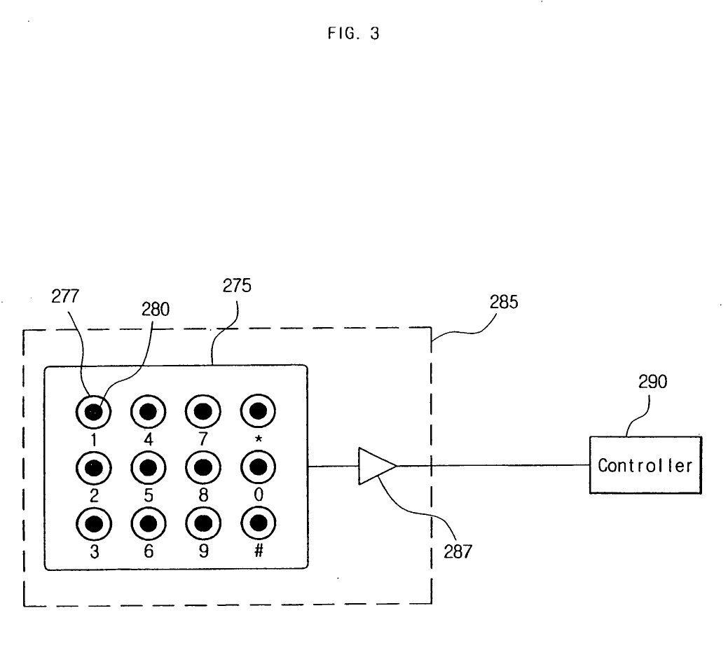

FIG. 3 is a block diagram of the car-call system using light sensor according to one embodiment of the present invention.

Referring to FIG. 3, the signal detector 285 using an optical sensor(e.g. IR sensor or LED sensor) 280 instead of the Piezzo buzzer is coupled to the controller 290 of the car-call system. The signal detector 285 using the optical sensor 280 includes a detector 275 having an optical sensor array and an amplifier 287 for amplifying electrical signal applied from the detector 275.

The detector 275 includes optical sensors 280 that are located at the inside of car and orderly arrayed toward the window of car. The optical sensor 280 generates a corresponding signal when the user sets or confirms the password having predetermined digits. Thus, if the user touches at least one of the optical sensors 280, each touched sensor generates an electrical signal. Here, the optical sensor 280 can be IR sensor.

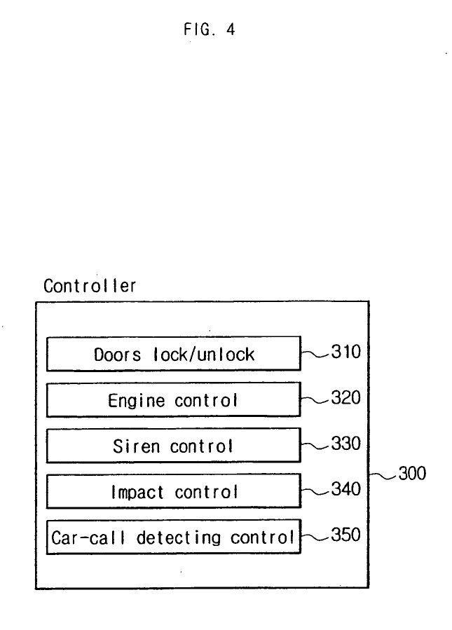

FIG. 4 is a block diagram showing the control function of the car-call system according to one embodiment of the present invention.

Referring to FIG. 4, the controller 300 of the car-call system performs an automatic door lock/unlock, an engine control 320, a siren control 330, an impact control 340 and a car-call detecting control 350.

Here, the car-call detecting control 350 interprets the electrical signals corresponding to the knocks or numbers inputted by the user according to the user password setup method or the password confirmation method, and performs the doors lock/unlock 310. The engine control 320 interprets the wireless signals transmitted by the remote controller to start or stop the engine. The impact control 340 drives the siren control in order to generate siren when an impact is applied to the car. Thus, each function of the controller 300 is connected to each other and controls automotive electrical components/equipments.

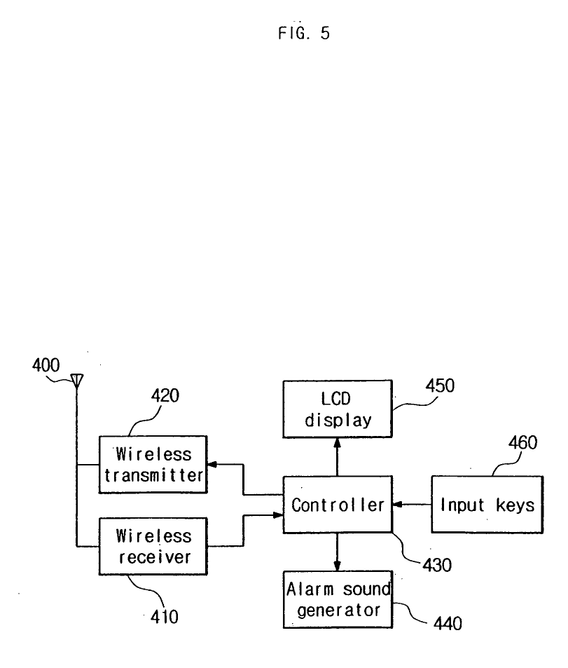

FIG. 5 is a block diagram of the remote controller according to one embodiment of the present invention.

Referring to FIG. 5, the remote controller includes an antenna 400, a wireless receiver 410, a wireless transmitter 420, a controller 430, an alarm sound generator 440, a LCD display 450 and input keys 460.

The wireless receiver 410 receives an automotive component status signal through the antenna 400 and outputs the received signal to the controller 430. Also, the wireless transmitter 420 transmits an automotive component control signal to the vehicle alarm device through the antenna 400.

The LCD display 450 outputs text messages corresponding to the control instruction that the controller 430 generates corresponding to the automotive component status signal. Also, the alarm sound generator 440 generates an alarm sound corresponding to the control instruction that the controller 430 generates corresponding to the automotive component status signal. Also, the input key 460 receives an automotive component control instruction from the user and sends it to the controller 430.

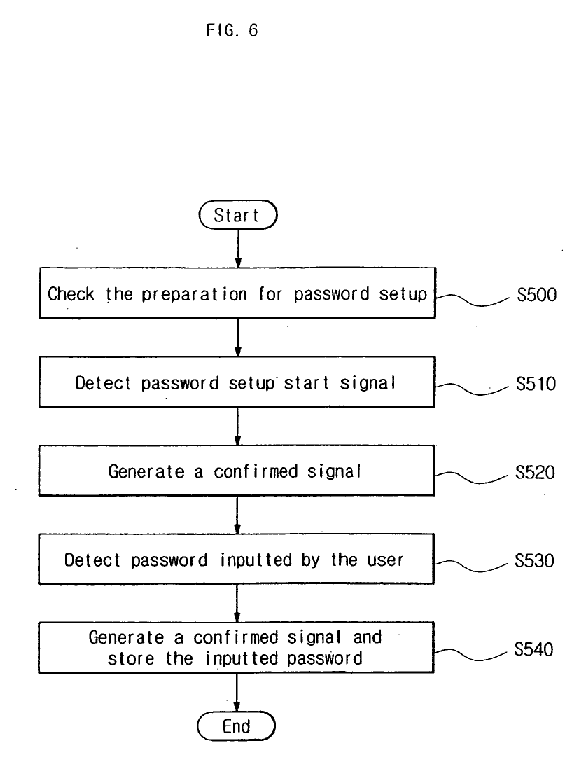

FIG. 6 is a flowchart of method for setting user password in the car-call system according to one embodiment of the present invention. Referring to FIG. 6, the method for setting user password to control the operation of the automotive component in the car-call system is as follows.

The car-call system checks the preparation for setting user password at step S500. For example, the car-call system checks that the door is open and the ignition key is on turn-on state. The car-call system detects a password setup start signal generated by the user from the signal detector at step S510. For example, the password setup start signal is knocks that are inputted at a predetermined interval and at the predetermined number of times. The password setup start signal is inputted accurately, then car-call system outputs a confirmed sound at step S520.

The car-call system detects signals corresponding to the password of predetermined digits through the signal detector at step S530. For example, one method for detecting signals corresponding to the password by using the Piezzo buzzer is as follows: (1) count how many times the user knocks for each digit and recognize the number of times of knocks as the number of that digit after the predetermined pause; and (2) repeat (1) as many as the number of digits that user selects. Another method for detecting signals corresponding to the password by using the optical sensor is as follows: (1) detect signals of predetermined digits after receiving the password setup start signal; and (2) then receive a password setup end signal from the user.

If the password is inputted normally, the car-call system generates a confirmed sound indicative of ending the password input and stores the password at step 540. Here, the device for storing password can be any kind of storage device such as memory or HDD. The aforementioned user password setup method can be applied to the password change or password reset.

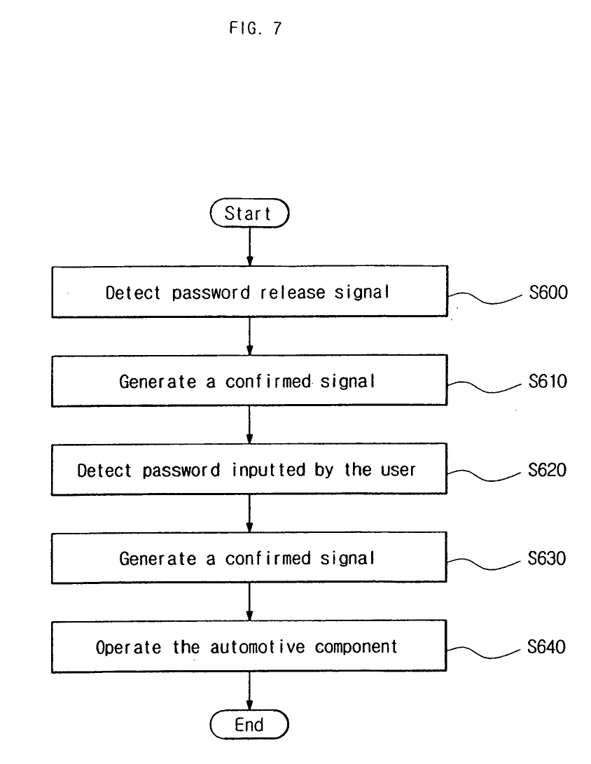

FIG. 7 is a flowchart of method for releasing user password in the car-call system according to one embodiment of the present invention. Referring to FIG. 7, the method for releasing user password to control the operation of the automotive component in the car-call system is as follows. The car-call system detects a password release start signal at step S600. For example, the signal detector of the car-call system detects the password release start knocks. If the password release start signal is inputted normally, the car-call system generates a confirmed sound indicative that the password release start signal is normally inputted at step S610.

The car-call system detects signals corresponding to the password of predetermined digits by use of the signal detector at step S620. The car-call system generates a confirmed sound when the password is inputted accurately at step S630.

Finally, after the predetermined time has passed, the car-call system operates the automotive component corresponding to the password at step S640. For example, after generating the confirmed sound, the car-call system unlocks the door of car or operates other automotive components.

According to one embodiment of the present invention, since the car-call system includes a function of setting and certifying passwords, so even if the user unlocks the door with leaving key or remote controller in the inside of car, the user can unlock doors or control automotive electrical components/equipments without key or remote controller.

And, according to one embodiment of the present invention, anyone can call the user directly from the car in the case of need.

Further, according to one embodiment of the present invention, the user can control the main functions of car without key or remote controller.

Although the present invention have been described by referring to some embodiments, the spirits and scope of the present invention are not limited to the described embodiment and it is also apparent that various changes and modifications can be made within the scope of the present invention by those who skilled in the art.

1. An apparatus for setting and releasing a user password to control automotive components in a car-call system, the apparatus comprising:
a signal detector configured to detect a physical signal that is applied to a car and convert the physical signal into an electrical signal;
a controller configured to analyze the electrical signal, store an entered password if the electrical signal is a password setup/change signal according to the analysis, control an operation of a corresponding automotive component if the electrical signal is a password release signal and an input password coincides with the stored password according to the analysis, and generate a user call signal if it is needed to call the user according to the analysis;
a wireless transmitter configured to wirelessly transmit the user call signal to a remote controller; and
a wireless receiver configured to wirelessly receive a vehicle control signal from the remote controller,
wherein said controller controls the operation of the corresponding automotive component based on the vehicle control signal.

2. The apparatus as stated in claim 1, wherein said signal detector comprises:
a piezoelectric element configured to convert a pressure, generated by a knock, into the electrical signal; and
an amplifier configured to amplify the electrical signal.

3. The apparatus as stated in claim 2, wherein said piezoelectric element is one of the following: a Piezzo buzzer, an impact sensor and a condenser microphone.

4. The apparatus as stated in claim 1, wherein the controller is configured to control operations of one of a door unlock and an engine start.

5. The apparatus as stated in claim 1, wherein the physical signal is an impact signal.

6. A method of setting a user password to control automotive components in a car-call system, said method comprising:
detecting a password setup signal that is applied to a car in the form of a physical signal having a predetermined format in a ready state so as to set a password;
generating a confirmed signal indicative of a normal password setup state, if the applied password setup signal corresponds to a stored password setup signal;
detecting a password that is applied to the car in the form of a physical signal having a predetermined format in the password setup state; and
storing the password after generating a confirmed signal indicative of the end of password input if the password is correctly entered.

7. The method as stated in claim 6, wherein said physical signal is detected by either a piezoelectric element or an optical sensor.

8. The method as stated in claim 6, wherein said password setup signal is a physical signal applied to the car with a predetermined interval and a predetermined number of times.

9. The method as stated in claim 6, wherein said detecting the password comprises:
(i) counting the number of physical signals that are applied to the car;
(ii) determining the number of physical signals as a number in each digit after detecting a predetermined pause; and
(iii) repeating (i) and (ii) until the number of digits of the determined number corresponds to a predetermined number of digits.

10. The method as stated in claim 7, wherein either the piezoelectric element or the optical sensor is located near the front window inside the car, and the physical signal is applied to a portion of the front window which is outside the car and near the piezoelectric element or the optical sensor.

11. The method as stated in claim 6, further comprising changing the set password.

12. A method of releasing a user password to control automotive components in a car-call system, said method comprising:
detecting a password release signal that is applied to a car in the form of a physical signal having a predetermined format;
generating a confirmed signal indicative of a normal password input state if the applied password release signal corresponds to a stored password release signal;
detecting a password that is applied to the car in the form of a physical signal having a predetermined format in the password input state; and
generating a confirmed signal indicative of a valid password and controlling a corresponding automotive component if the applied password corresponds to the stored password.

13. The method as stated in claim 12, wherein said physical signal is detected by either a piezoelectric element or optical sensor.

14. The method as stated in claim 12, wherein said password release signal is applied to the car at a predetermined interval and in a predetermined number of times.

15. The method as stated in claim 12, wherein said detecting the password comprises:
(i) counting the number of physical signals that are applied to the car;
(ii) determining the number of physical signals as a number in each digit after detecting a predetermined pause;
(iii) repeating said (i) and (ii) until the number of digits of the determined numbers corresponds to a predetermined number of digits.

16. A method of controlling operations of automotive components based on a user password, the method comprising:
detecting an impact applied to a vehicle, wherein the impact is associated with a user password;
converting the detected impact into an electrical signal;
decoding the electrical signal into a user password;
comparing the user password with a previously stored user password; and
controlling the automotive components based on the comparison.

17. The method of claim 16, wherein the impact includes the combination of a plurality of knockings applied on an external portion of the vehicle.

18. The method of claim 16, wherein the detecting is made with the use of one of the following: a Piezzo buzzer, an impact sensor and a condenser microphone.

19. The method of claim 16, wherein the controlling comprises performing the operations of one of a door unlock and an engine start.

20. An apparatus for controlling operations of automotive components based on a user password, the apparatus comprising:
means for detecting an impact applied to a vehicle, wherein the impact is associated with a user password;
means for converting the detected impact into an electrical signal;
means for decoding the electrical signal into a user password;
means for comparing the user password with a previously stored user password; and
means for controlling the automotive components based on the comparison.
